(19) United States
(12) Patent Application Publication
(10) Pub. No.: US 2009/0210876 A1
(43) Pub. Date: Aug. 20, 2009

(54) Pull-model Workload Management with Synchronous-Asynchronous-Synchronous Bridge

(76) Inventors: Jinmei Shen, Rochester, MN (US); Hao Wang, Rochester, MN (US)

Correspondence Address: IBM CORPORATION, 3605 HIGHWAY 52 NORTH, DEPT. 917, BUILDING 006-1, ROCHESTER, MN, 55901-7829, US

(21) Appl. No.: 12/034,355

(22) Filed: Feb. 20, 2008

(51) Int. Cl. G06F 9/46

(52) U.S. Cl. 718/100

(57) ABSTRACT

A method, computer program product and computer system for workload management that distributes job requests to a cluster of servers in a computer system, which includes queuing job requests to the cluster of servers, maintaining a processing priority for each of the job requests, and processing job requests asynchronously on the cluster of servers. The method, computer program product and computer system can further include monitoring the job requests and dynamically adjusting parameters of the workload management.

### BACKGROUND

1. Technical Field

The present invention relates to workload management. More specifically, it relates pull-model workload management with a synchronous-asynchronous-synchronous bridge.

2. Background Information

Workload management refers to the process that manages a set of serial or parallel jobs over a cluster of servers. Workload management enables a computer system to manage workload distributions to provide optimal performance for users and applications. It is fundamental to many e-business infrastructure systems. Workload management typically works in a mode that routes client requests to one of many clustered servers, which is known as the “push model”. However, a lot of overheads are required for the push model to propagate routing tables, server capacity information, health information, and load information to client routers or gateway routers. Moreover, router information always lags behind the changes of server conditions. Hence, the conditions of a server are sometimes different from those that client routers used to make their decisions when routing a client request to this server. So, it could happen that when the client request arrives at a server, the server is over-loaded although it was under-loaded before, or the server is already “dead” or malfunctioning.

Workload can be synchronous or asynchronous. Most Internet workload or Internet applications are client-server synchronous and interactive. Usually when a request to a server is sent from a client program, e.g. a web browser, a response will be received immediately. All Internet applications require gateways and/or routers to distribute requests into multiple servers, which are usually of limited scope due to the overheads required to keep routing tables updated for any server state changes. In contrast, scientific computing workloads are usually asynchronous and non-interactive. Results are checked after a period of time after a job is submitted. Scientific computing does not track the changes of server states. Jobs are sent to a queue. All servers have access to this queue, and servers with free available computing resources will retrieve jobs from the queue, carry out computations, and put results back into the queue after the computations are done. Current business computing techniques, even grid computing, cannot handle synchronous workloads such as interactive Internet information and transactional applications efficiently.

### SUMMARY

A method, computer program product and computer system for workload management that distributes job requests to a cluster of servers in a computer system, which includes queuing job requests to the cluster of servers, maintaining a processing priority for each of the job requests, and processing job requests asynchronously on the cluster of servers. The method, computer program product and computer system can further include monitoring the job requests and dynamically adjusting parameters of the workload management.

### BRIEF DESCRIPTION OF DRAWINGS

FIG. 1 is a block diagram of the components of the present invention.

FIG. 2 is a flowchart illustrating the conversion of a synchronous request to asynchronous processing.

FIG. 3 is a flowchart showing a process where a server pulls a request according to its capacity, the current conditions and the urgencies of jobs.

FIG. 4 is a flowchart showing a process where a system updates the urgency of a request to make sure the request is processed within the required time.

FIG. 5 is a flowchart illustrating the response time control of a system.

FIG. 6 is a flowchart showing timeout control and timeouts coordination.

FIG. 7 is a flowchart illustrating runtime thresholds updating.

FIG. 8 is a conceptual diagram of a computer system in which the present invention can be utilized.

### DETAILED DESCRIPTION

The invention will now be described in more detail by way of example with reference to the embodiments shown in the accompanying Figures. It should be kept in mind that the following described embodiments are only presented by way of example and should not be construed as limiting the inventive concept to any particular physical configuration. Further, if used and unless otherwise stated, the terms “upper,” “lower,” “front,” “back,” “over,” “under,” and similar such terms are not to be construed as limiting the invention to a particular orientation. Instead, these terms are used only on a relative basis.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable media may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Turning to the present invention, instead of using a push model, the present invention adopts a pull model for workload management. In pull-model workload management, client requests to one of many clustered serves are sent to all servers in a queue, and a server pulls a request task from the queue when the server is available and has free resources to handle this request. The present invention enables the elimination of most push model overheads and time lags between the changes of server states and the updates of router information. Therefore, client requests can be handled more effectively and efficiently according to their classification and QoS (Quality of Service) requirements. Moreover, the present invention utilizes a synchronous-asynchronous-synchronous bridge that converts traditional synchronous internet requests or responses to resource-aware and response-sensitive asynchronous processing, which further improves the performance of our pull-model workload management.

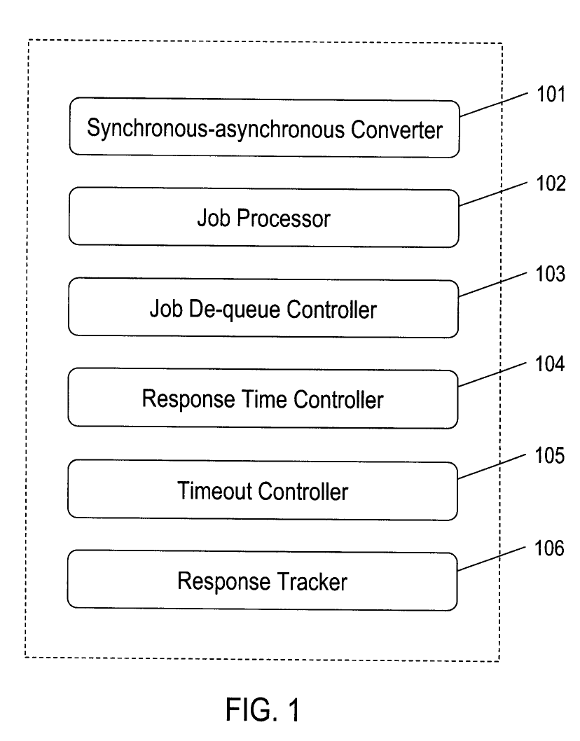

One embodiment of the present invention includes 6 components, as illustrated in FIG. 1.
(1) a Synchronous-asynchronous Converter 101, which creates a job entry for a synchronous job request, adds the job entry into a local job requests queue (e.g. a distributed job map), creates events, and waits for event notifications or response-time notifications that come from different urgencies that indicates processing priorities of different jobs;
(2) a Job Processor 102, which retrieves a job entry from the distributed job map with a Job De-queue Controller in each server, updates the job entry with results after the job is finished, and records type and processing time statistics;
(3) a Job De-queue Controller 103, which specifies policies to get different jobs from the local distributed job map (e.g. current available server memory, CPU, threads, and resources, etc), and policies to retrieve from the queue (e.g. priority, urgencies, status, QoS, classification, etc.);
(4) a Response-time Controller 104, which tracks the time elapsed and the time left for processing a request, and creates an event to update map job entries with different priority levels, or urgencies. For example, if an interactive request is supposed to be sent back to a user within 5 seconds, 1 second has already elapsed, and the average processing time for this kind of jobs is 2 seconds, an event will be called to check the entry of this job to see if this job is already in processing or still in the distributed map waiting to be processed. If it is still waiting, its urgency value will be raised to 3 so that it can be processed quicker; if 2 seconds have elapsed and this job is still in the distributed map or in the queue, its urgency will be raised to 2; and if 3 seconds have elapsed, its urgency will be changed to 1 which will also change the processing thread priority even if this request job is in processing;
(5) a Timeout Controller 105, which compares the elapsed time to the timeout value when timeout is approaching, and updates the distributed map job entry with higher urgencies; and
(6) a Response Tracker 106, which monitors interactive clients and requests being processed, their stages in job entries, in the processing queue, in response-time controller urgency updating phases, in timeout controller updated phases, in response phases and in exception phases; and tracks a ratio of response time against average processing time, required response time and timeout, to dynamically adjust thresholds so that asynchronous grid computing is more responsive to synchronous clients/users requests.

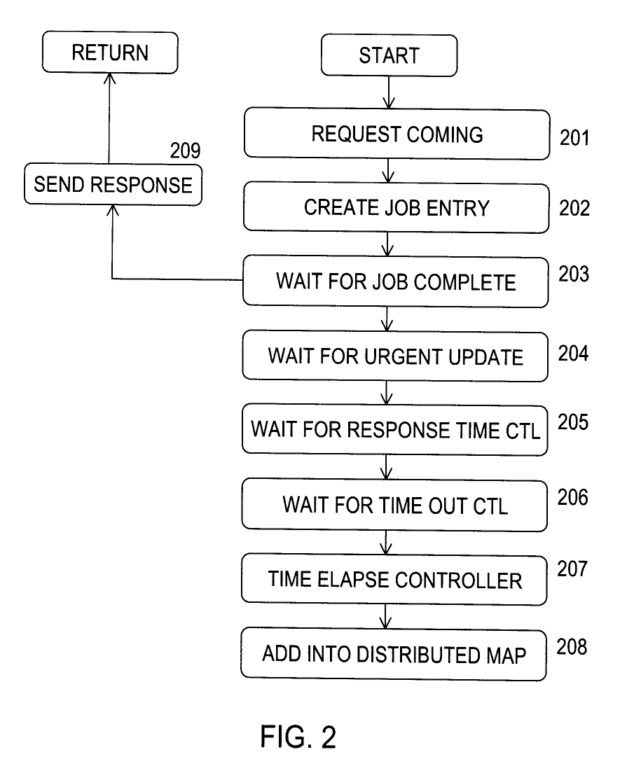

The flowcharts in FIG. 2-FIG. 7 illustrate how pull model workload management handles synchronous interactive requests.

FIG. 2 shows the conversion of a synchronous client request to asynchronous job processing. First, a user makes a synchronous interactive request to a system (state 201) and waits for its response, the system then creates a job entry using synchronous-asynchronous converter 101 (state 202) and waits for the job completion call back (state 203). During the process, the system will use the response time controller 104 to handle urgency updates (state 204) and to response time control (state 205), use the timeout controller 105 to perform timeout control (state 206) and to create a timer to calculate elapse time (state 207), put this request into distributed map using synchronous-asynchronous converter 101 (state 208) and wait for any server to pull this job to process using the job process 102 and the job de-queue controller 103. Once the job is done asynchronously, it is called back. The system then releases the lock and sends the response back to user in a synchronous manner (state 209). The process is called the “synchronous-asynchronous-synchronous bridge”.

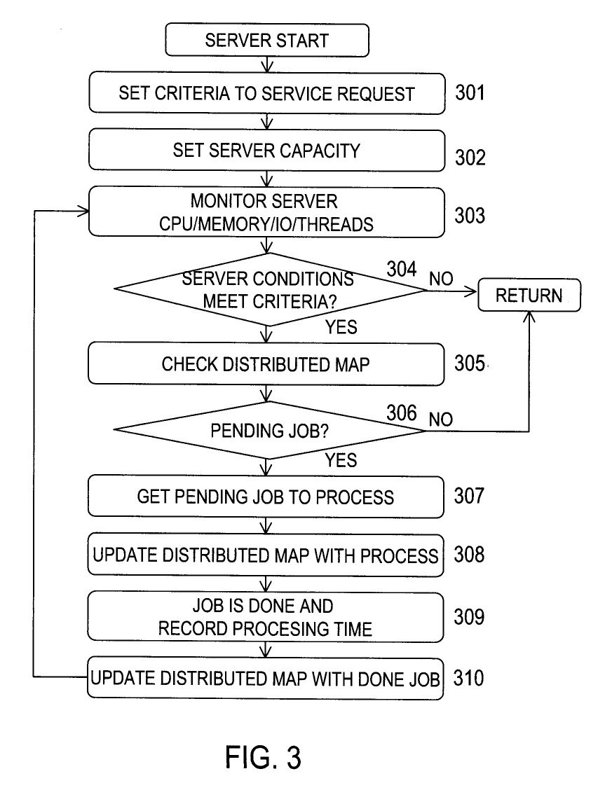

FIG. 3 further illustrates how a server pulls a request according to its capacity, the current conditions (e.g. CPU, memory, I/O, threads, server health, resources, availability) and the urgencies and priorities of jobs (i.e. state 203 in FIG. 2). After the server is started, it sets criteria for different service requests (state 301), sets a server capacity to limit the requests it can process (state 302), and monitors server conditions (state 303). If server conditions meet the criteria (state 304), the server will check the job distribution map (state 305). If there are pending jobs (state 306), it will pull jobs from the distributed map for processing (state 307), and updates distributed map with job processing status (state 308); when a job is processed, processing time and average processing time will be recorded (state 309), and results will be send back. The distributed job map will then be updated with the finished job (state 310). Another job will be processed until the server is stopped or no jobs meet the criteria.

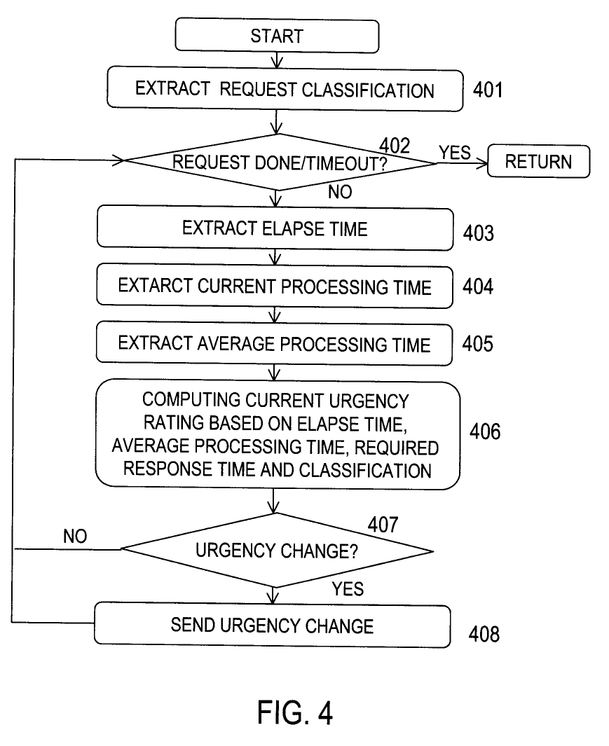

FIG. 4 further shows how system updates urgency to make sure a request is processed within a required time (state 204 in FIG. 2). The response time controller 104 first extracts the classification of a client request (state 401). If the request is not finished and the timeout is not reached (state 402), the system will extract elapse time (state 403), current processing time (state 404) and average processing time (state 405). It will then use the classification, elapse time, current processing time and average processing time to calculate current urgency rating of the request (state 406). If the urgency value changes (state 407), the system will send the change value (state 408). Otherwise, it will continue the “waiting for urgency update” process (state 204 in FIG. 2).

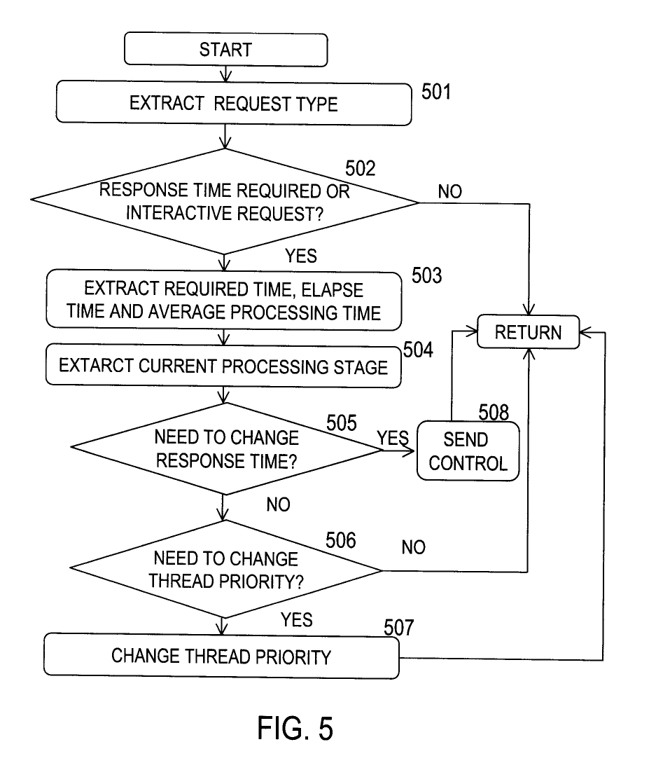

FIG. 5 illustrates the response time control of a system. The response time controller 104 first extracts the type of a client request (state 501). If there is a required response time or the request is interactive (state 502), the response time controller 104 will extract current required time, elapsed time and average processing time (state 503), and extract current processing stage (state 504), If the response time needs to be changed (state 505), a control will be sent (state 508). Otherwise, the response time controller 104 will check whether the threshold priority needs to be changed (state 506), and change it if necessary (state 507).

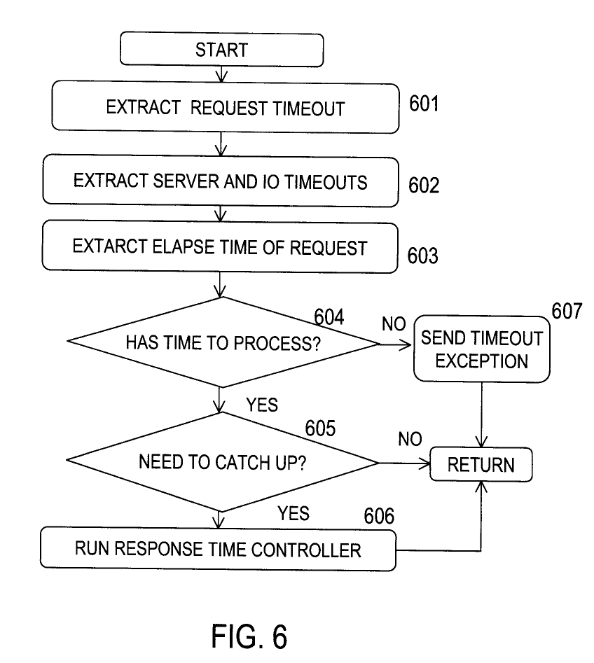

FIG. 6 shows how the present invention controls timeout and coordinates different timeouts. First, the timeout controller 105 extracts the timeout of a client request (state 601), the server and I/O timeouts (state 602) and the elapsed time of the request (state 603). If there is no enough time to process the request (state 604), a timeout exception will be sent (state 607). Otherwise, the timeout controller 105 will check if the client request needs to catch up (state 605) and run response time controller 104 (state 606) if a catch-up is necessary.

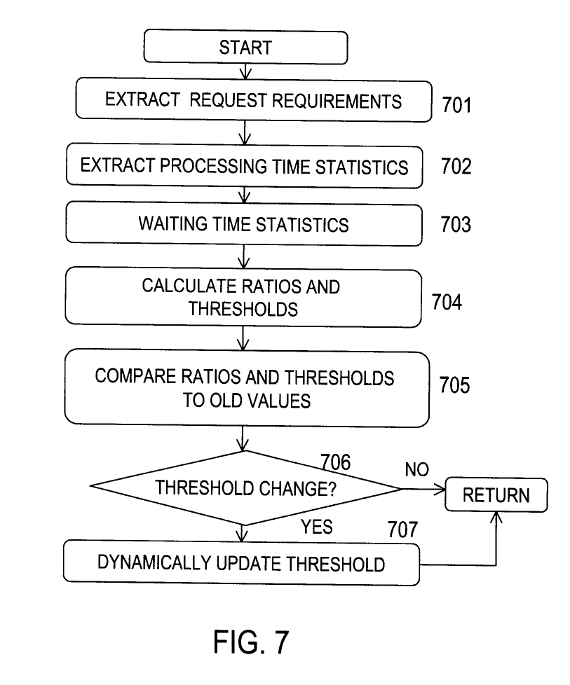

FIG. 7 shows how thresholds are updated dynamically at runtime to ensure the timely scheduling of a client request. First the system will extract the requirements of the request (state 701), the processing time statistics (state 702), and waiting time statistics (state 703). It will then calculate ratios and thresholds (state 704), and compare the calculated ratios and thresholds to old values (state 705). If the threshold has been changed (state 706), the threshold will dynamically update the threshold (state 707).

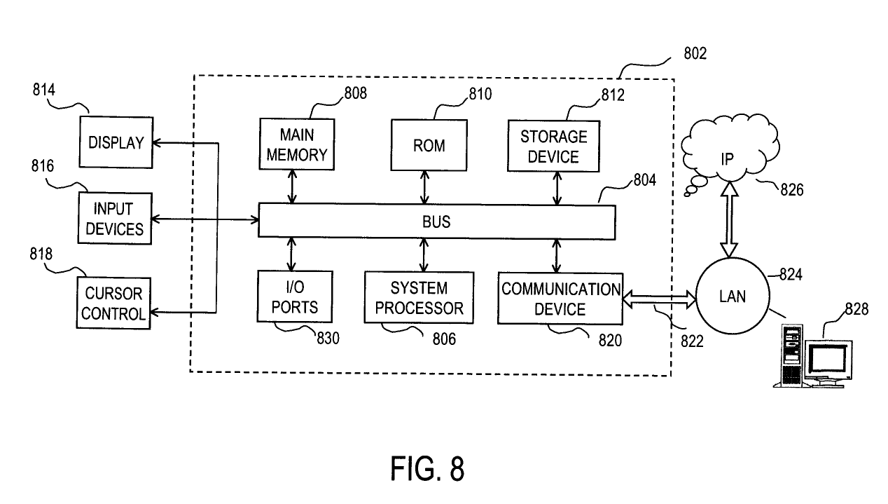

FIG. 8 illustrates a computer system (802) upon which the present invention may be implemented. The computer system may be any one of a personal computer system, a work station computer system, a lap top computer system, an embedded controller system, a microprocessor-based system, a digital signal processor-based system, a hand held device system, a personal digital assistant (PDA) system, a wireless system, a wireless networking system, etc. The computer system includes a bus (804) or other communication mechanism for communicating information and a processor (806) coupled with bus (804) for processing the information. The computer system also includes a main memory, such as a random access memory (RAM) or other dynamic storage device (e.g., dynamic RAM (DRAM), static RAM (SRAM), synchronous DRAM (SDRAM), flash RAM), coupled to bus for storing information and instructions to be executed by processor (806). In addition, main memory (808) may be used for storing temporary variables or other intermediate information during execution of instructions to be executed by processor. The computer system further includes a read only memory (ROM) 810 or other static storage device (e.g., programmable ROM (PROM), erasable PROM (EPROM), and electrically erasable PROM (EEPROM)) coupled to bus 804 for storing static information and instructions for processor. A storage device (812), such as a magnetic disk or optical disk, is provided and coupled to bus for storing information and instructions. This storage device is an example of a computer readable medium.

The computer system also includes input/output ports (830) to input signals to couple the computer system. Such coupling may include direct electrical connections, wireless connections, networked connections, etc., for implementing automatic control functions, remote control functions, etc. Suitable interface cards may be installed to provide the necessary functions and signal levels.

The computer system may also include special purpose logic devices (e.g., application specific integrated circuits (ASICs)) or configurable logic devices (e.g., generic array of logic (GAL) or re-programmable field programmable gate arrays (FPGAs)), which may be employed to replace the functions of any part or all of the method as described with reference to FIG. 1. Other removable media devices (e.g., a compact disc, a tape, and a removable magneto-optical media) or fixed, high-density media drives, may be added to the computer system using an appropriate device bus (e.g., a small computer system interface (SCSI) bus, an enhanced integrated device electronics (IDE) bus, or an ultra-direct 15 memory access (DMA) bus). The computer system may additionally include a compact disc reader, a compact disc reader-writer unit, or a compact disc jukebox, each of which may be connected to the same device bus or another device bus.

The computer system may be coupled via bus to a display (814), such as a cathode ray tube (CRT), liquid crystal display (LCD), voice synthesis hardware and/or software, etc., for displaying and/or providing information to a computer user. The display may be controlled by a display or graphics card. The computer system includes input devices, such as a keyboard (816) and a cursor control (818), for communicating information and command selections to processor (806). Such command selections can be implemented via voice recognition hardware and/or software functioning as the input devices (816). The cursor control (818), for example, is a mouse, a trackball, cursor direction keys, touch screen display, optical character recognition hardware and/or software, etc., for communicating direction information and command selections to processor (806) and for controlling cursor movement on the display (814). In addition, a printer (not shown) may provide printed listings of the data structures, information, etc., or any other data stored and/or generated by the computer system.

The computer system performs a portion or all of the processing steps of the invention in response to processor executing one or more sequences of one or more instructions contained in a memory, such as the main memory. Such instructions may be read into the main memory from another computer readable medium, such as storage device. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The computer system also includes a communication interface coupled to bus. The communication interface (820) provides a two-way data communication coupling to a network link (822) that may be connected to, for example, a local network (824). For example, the communication interface (820) may be a network interface card to attach to any packet switched local area network (LAN). As another example, the communication interface (820) may be an asymmetrical digital subscriber line (ADSL) card, an integrated services digital network (ISDN) card or a modem to provide a data communication connection to a corresponding type of telephone line. Wireless links may also be implemented via the communication interface (820). In any such implementation, the communication interface (820) sends and receives electrical, electromagnetic or optical signals that carry digital data streams representing various types of information.

Network link (822) typically provides data communication through one or more networks to other data devices. For example, the network link may provide a connection to a computer (826) through local network (824) (e.g., a LAN) or through equipment operated by a service provider, which provides communication services through a communications network (828). In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit notifications and receive data, including program code, through the network(s), the network link and the communication interface.

It should be understood, that the invention is not necessarily limited to the specific process, arrangement, materials and components shown and described above, but may be susceptible to numerous variations within the scope of the invention.

What is claimed is:

1. A method for workload management that distributes synchronous job requests to a cluster of servers in a computer system, comprising:
converting a synchronous job request of a client to an asynchronous job request;
handling the asynchronous job request; and
returning processing results of the asynchronous job request as a synchronous response to the client.

2. The method of claim 1, wherein the handling comprises:
maintaining a job requests queue;
queuing the asynchronous job request to the job requests queue;
maintaining a processing priority for the asynchronous job request; and
processing the asynchronous job request in the job requests queue on the cluster of servers according to the processing priority.

3. The method of claim 2, wherein the queuing comprises:
creating a job entry for the asynchronous job request; and
adding the job entry to the job requests queue.

4. The method of claim 2, wherein the maintaining a processing priority comprises:
tracking time elapsed and time left for the asynchronous job request; and
updating the processing priority of the asynchronous job request according to pre-determined rules.

5. The method of claim 4, wherein the rules comprise a timeout rule that increases the processing priority of the asynchronous job request if time elapsed of the asynchronous job request is closer to a timeout threshold, and the updating comprises comparing the time elapsed of the asynchronous job request to the timeout threshold, and increasing the processing priority of the asynchronous job request according to the timeout rule.

6. The method of claim 2, wherein the processing comprises:
de-queuing the asynchronous job request from the job requests queue according to pre-determined policies when a server is available;
updating the job requests queue after the de-queuing; and
performing the requested asynchronous job on the server;

7. The method of claim 1, further comprising monitoring job requests and dynamically adjusting parameters of the workload management.

8. A computer program product for workload management that distributes job requests to a cluster of servers in a computer system, the computer program product comprising:
a computer usable medium having computer usable program code embodied therewith, the computer usable program code comprising:
instructions to convert a synchronous job request of a client to an asynchronous job request;
instructions to handle the asynchronous job request; and
instructions to return processing results of the asynchronous job request as a synchronous response to the client.

9. The computer program product of claim 8, wherein the instructions to handle comprises:
instructions to maintain a job requests queue;
instructions to queue the asynchronous job request to the job requests queue;
instruction to maintain a processing priority for the asynchronous job request; and
instructions to process the asynchronous job request in the job requests queue on the cluster of servers according to the processing priority.

10. The computer program product of claim 9, wherein the instructions to queue comprises:
instructions to create a job entry for the asynchronous job requests; and
instructions to add the job entry to the job requests queue.

11. The computer program product of claim 9, wherein the instructions to maintain a processing priority comprises:
instructions to track time elapsed and time left for the asynchronous job request;
instructions to update the processing priority of the asynchronous job request according to pre-determined rules.

12. The computer program product of claim 11, wherein the rules comprise a timeout rule that increases the processing priority of the asynchronous job request if time elapsed of the asynchronous job request is closer to a timeout threshold, and the instructions to update comprises instructions to compare the time elapsed of the asynchronous job request to the timeout threshold, and instructions to increase the processing priority of the asynchronous job request according to the timeout rule.

13. The computer program product of claim 9, wherein the instructions to process comprises:
instructions to de-queue the asynchronous job request from the job requests queue according to pre-determined policies when a server is available;
instructions to update the job requests queue after the de-queuing of the asynchronous job request; and
instructions to perform the requested asynchronous job on the server;

14. The computer program product of claim 8, further comprising instructions to monitor job requests and to dynamically adjust parameters of the workload management.

15. A computer system comprising:
a processor;
a memory operatively coupled with the processor;
a storage device operatively coupled with the processor and the memory; and
a computer program product for workload management that distributes job requests to a cluster of servers in a computer system, the computer program product comprising:
a computer usable medium having computer usable program code embodied therewith, the computer usable program code comprising:
instructions to convert a synchronous job request of a client to an asynchronous job request;
instructions to handle the asynchronous job request; and
instructions to return processing results of the asynchronous job request as a synchronous response to the client.

16. The computer system of claim 15, wherein the instructions to handle comprises:
instructions to maintain a job requests queue;
instructions to queue the asynchronous job request to the job requests queue;
instructions to maintain a processing priority for the asynchronous job request; and
instructions to process the asynchronous job request in the job requests queue on the cluster of servers according to the processing priority.

17. The computer system of claim 16, wherein the instructions to queue comprises:
instructions to create a job entry for the asynchronous job requests; and
instructions to add the job entry to the job requests queue.

18. The computer system of claim 16, wherein the instructions to maintain a processing priority comprises:
instructions to track time elapsed and time left for the asynchronous job request; and
instructions to update the processing priority of the asynchronous job request according to pre-determined rules.

19. The computer system of claim 18, wherein the rules comprise a timeout rule that increases the processing priority of the asynchronous job request if time elapsed of the asynchronous job request is closer to a timeout threshold, and the instructions to update comprises instructions to compare the time elapsed of the asynchronous job request to the timeout threshold, and instructions to increase the processing priority of the asynchronous job request according to the timeout rule.

20. The computer system of claim 16, wherein the instructions to process comprises:
instructions to de-queue the asynchronous job request from the job requests queue according to pre-determined policies when a server is available;
instructions to update the job requests queue after the de-queuing of the asynchronous job request; and
instructions to perform the requested asynchronous job on the server;
